(19) United States
(12) Patent Application Publication
(10) Pub. No.: US 2016/0110557 A1
(43) Pub. Date: Apr. 21, 2016

(54) BASE MODULE FOR ELECTRONIC DEVICE

(71) Applicant: WEIDMÜLLER INTERFACE GMBH & CO. KG, Detmold (DE)

(72) Inventor: Stefan Woesten, Detmold (DE)

(21) Appl. No.: 14/892,876

(22) PCT Filed: May 21, 2014
(86) PCT No.: PCT/EP2014/060437

§ 371 Date: Nov. 20, 2015

(30) Foreign Application Priority Data
May 29, 2013 (DE) 10 2013 105 516.8

(51) Int. Cl. G06F 21/62; G06F 21/31

(52) U.S. Cl. CPC G06F 21/629; G06F 21/31

(57) ABSTRACT

A base module for an electronic device connects an application module in the electronic device to a network. The base module includes a memory unit which stores a program which defines a function of the electronic device. The base module also includes a modification device for modifying settings on the program in accordance with user input via a switch. A specified electric switch state for the base module is required in order to modify at least some of the settings.

### CROSS REFERENCE TO RELATED APPLICATIONS

This application is a national stage application under 35 C.F.R. §371 of the PCT International Application No. PCT/EP2014/060437 filed May 21, 2014, which claims priority of the German Application No. DE102013105516.8 filed May 29, 2013. The entire content of these applications is incorporated herein by reference.

### BACKGROUND OF THE INVENTION

The invention relates to a base module for an electronic device for connecting an application module in the electronic device with a network and for an electronic device including a base module.

### BRIEF DESCRIPTION OF THE PRIOR ART

A field bus connection module, also referred to as a field bus coupler, is known from the prior art as evidenced by German printed specification No. DE 44 38 806 C. The filed bus connection module is connected with application modules in the electronic device to connect them with a network designed as a field bus. The application modules are used for the output or acquisition of electrical signals. Such a field bus connection module is an example of the base module referred to above.

Such a base module normally operates under program control, wherein the program and operating parameters of the program or other adjustments of the base module are managed, maintained, updated and modified, usually via the network. For this purpose, the base module is protected from alteration by an access password. In this manner, unintentional or unauthorized changes on the program or other adjustments are prevented.

However, a disadvantage of using such an access password is that no access to the program and adjustment of the base module is possible if the access password is lost. The base module would then have to be returned to the manufacturer for setting a new access password. Although some type of master password could also be used, this will create a security problem since if the master password becomes known, the access password can then be changed via the network in an unauthorized manner.

Therefore the object of the invention is to provide improved access protection for the known base module.

### SUMMARY OF THE INVENTION

According to one aspect of the present invention, a base module for an electronic device for connecting an application module in the electronic device to a network includes a program which is stored in a memory unit and which defines a function of the electronic device and a modification device for modifying settings on the program stored in the memory unit on the basis of a user input with a specified electric switch state for the base module being required to modify at least one of the settings.

According to the present invention, modification of specific parts of the program stored in the memory is permitted only within the scope of a specific state of the electric switch. Compared to an electronic switch state, which describes the information conditions within the base module, an electric switch state describes the electrical energy transfer conditions to or within the base module. Within the scope of an electric switch state, the electrical connections to the base module or within the base module will therefore be specifically interrupted or established. The connections can be rearranged by specific settings of a switch.

In this manner, the part of the program stored in the memory unit describing the access password can be effectively protected against unauthorized access since the access password can only be changed on the base module on-site. However, other program components which are not be accessible for modification via the network can be protected with the base module in the same manner.

In a preferred embodiment of the base module, the specified electric switch state includes a separate electrical connection to the application module. In this manner, it is necessary to disconnect the base module from the application modules to change the access password, for example. Any unintentional modification of the program, other adjustments, or the access password (via the network, for example) is thus impossible during the operation of the electronic device.

In a further embodiment of the base module, the electrical connection includes a data connection. In this manner, it is easy to determine using information technology whether the specified electric switch state has been reached that is necessary to change the program settings in order to change the access password.

In a further embodiment of the base module, the settings which can be changed in the specified electric switch state include the previously mentioned access password, which secures access to parameters and program structures in the program stored in the memory unit. The access password is protected in a simple and comprehensible manner by the base module, because no external access to the access password is possible via the network.

According to a further embodiment of the invention, an electronic device includes a base module and an application module which can be connected to a network via the base module.

In another embodiment of the electronic device, the application module is connected with the base module electrically, optically and/or mechanically.

In a further embodiment of the electronic device, the network is a field bus.

In yet another embodiment of the electronic device, the application module includes a sensor, an actuator or a field device, which is part of a production process.

### BRIEF DESCRIPTION OF THE FIGURES

Other objects and advantages of the invention will become apparent from a study of the following specification when viewed in the light of the accompanying drawing, in which:

FIG. 1 is a schematic diagram of a network including electronic devices having base modules; and

FIG. 2 is a schematic diagram of the network of FIG. 1 in another operating mode.

### DETAILED DESCRIPTION

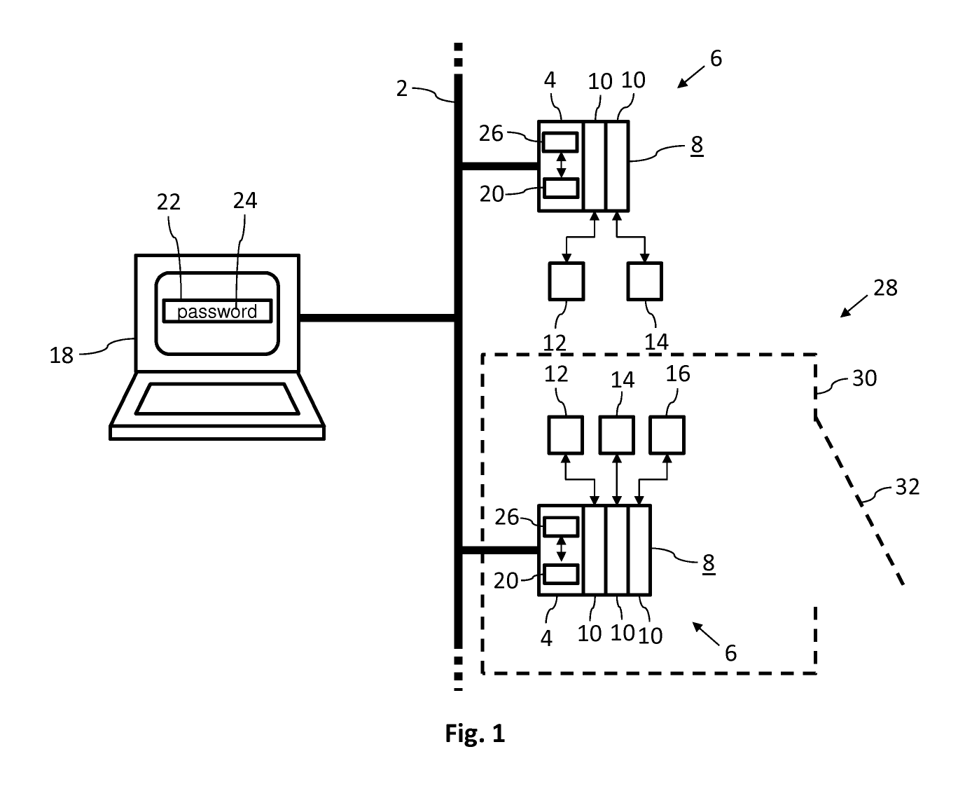

Referring to FIG. 1, there is shown a schematic diagram of a network 2 with electronic devices 6 including a base module 4.

By way of example, the network 2 is preferably a field bus which consolidates the sensors and actuators into control circuits below a control level for establishing reference variables in an industrial facility. These types of field buses, such as CAN-open (controller area network), PROFIBUS, PROFINET and EtherCAT for example, are known to those of ordinary skill in the art and will subsequently not be described in further detail.

The individual electronic devices 6 are arranged in a modular control system such as is known from DE 44 38 806 C1 for example. Within this configuration, the individual electronic devices include the respective base module 4 which is also designated as a field bus coupler of an automation control system.

Application modules 8 are connected to the network 2 via the individual base modules 4. The individual application modules 8 are made up of signal conductor discs 10 and supply discs which are used for controlling the sensors 12, actuators 14 and other field devices 16.

In the embodiment of FIG. 1, the electronic devices 6 are controlled from a higher-level master computer 18, also referred to as a control computer or programmable logic controller, to receive the reference variables.

Programming tasks on the base modules 4 are carried out by the master computer 18. In this context, programs can be incorporated, modified or deleted in a memory 20 of the individual base modules 4 by the master computer 18. The programs describe the functionality of the base module 4 or of the entire electronic device 6.

To prevent accidental changes of the programs in the memory units 20 of the base module 4 of the electronic devices 6, a user input 22 for an access password 24 is provided before a change is made in the programs in the memory units 20. The program changes in the electronic devices can only be made input of the access password.

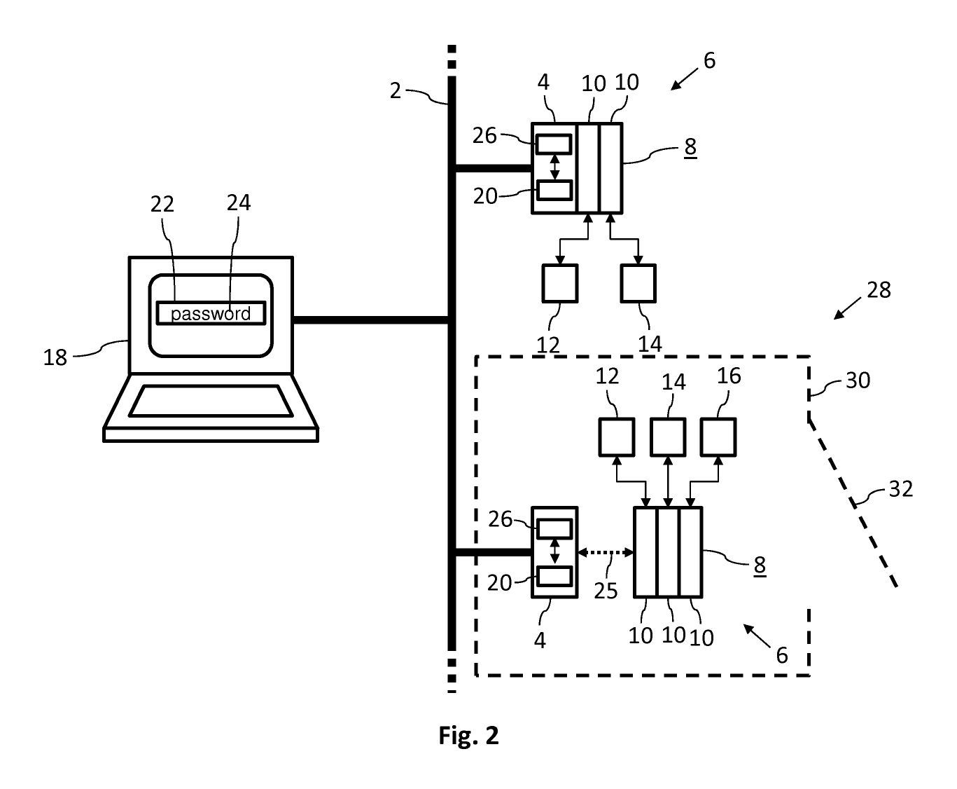

However, in the event that the access password 24 is lost because the user has forgotten it for example, the access password 24 can be reset via the master computer 18. However, users must initially place the respective electronic device 6 into a special electrical state, an example of which is illustrated in FIG. 2 with the aid of the electronic device 6 illustrated at the bottom in the figure.

As shown in FIG. 2, the base module 4 is electrically separated or disconnected from the application module 8 in this special electrical state. In the present embodiment, the electrical separation 25 includes the electrical separation 25 of all lines carrying information. If desired, electrical separation of all electrical energy supply lines between the base module and 4 and the application module 8 can be provided.

For this purpose, each of the individual electrical devices 6 includes a modification device 26 which records the electrical separation 25 between the base module 4 and the application module 8 and only enables access to a memory area in the memory unit 20 following the recorded electrical separation 25. The memory unit permits the modification of the access password 24 by the master computer 18, for example.

Alternatively, the modification device 26 also includes an intrinsic input device for changing the access password 24. In this manner, in the event that the master computer 18 and the electronic device 6 on which the access passwords is to be reset are located far apart, the user would not have to move around.

To increase security against unlawful manipulation, individual electronic devices 6 or all electronic devices 6 can be accommodated in one lockable switch cabinet 28, which for simplicity's sake is indicated by a square drawn with dashed lines in FIGS. 1 and 2. In this context, the switch cabinet 28 includes a cabinet housing 30 containing the respective electronic device or devices 6. The cabinet housing 30 is secured against unauthorized access by a lockable door 32.

A switch is provided on the door 32. The switch is connected to the electronic device 6 and sends a signal to indicate an open door. The state of the switch contact is considered to be the specified switch state which is a prerequisite for modifying the access password 24, for example.

While the preferred forms and embodiments of the invention have been illustrated and described, it will be apparent to those of ordinary skill in the art that various changes and modifications may be made without deviating from the inventive concepts set forth above.

1-8. (canceled)

9. A base module for an electronic device for connecting an application module in the electronic device to a network, comprising
a. a memory unit storing a program which defines a functionality of the electronic device; and
b. a modification device for modifying settings on the program stored in the memory unit in accordance with the operation of a user input, wherein the module is operable between a specified electrical switch state in which the modification device may modify at least some of the program settings and another switch state in which the modification device is prevented from modifying the program settings.

10. The base module as defined in claim 9, wherein the specified electrical switch state comprises a separate electrical connection to the application module.

11. The base module as defined in claim 10, wherein the separate electrical connection comprises a data connection.

12. The base module as defined in claim 9, wherein the settings which can be changed in the specified electrical switch state include an access password which secures access of parameters and program structures to the program stored in the memory unit.

13. An electronic device, comprising
a. a base module including a memory unit storing a program which defines a functionality of the electronic device and a modification device for modifying settings on the program stored in the memory unit in accordance with the operation of a user input, wherein the module is operable between a specified electrical switch state in which the modification device may modify at least some of the program settings and another switch state in which the modification device is prevented from modifying the program settings; and
b. an application module connected to a network via the base module.

14. The electronic device as defined in claim 13, wherein the application module is connected with the base module via at least one of an electrical, optical and mechanical connection.

15. The electronic device as defined in claim 13, wherein the network is a field bus.

16. The electronic device as defined in claim 13, and further comprising at least one of a sensor, an actuator, and a field device connected with said application module.
